(19) United States
(12) Patent Application Publication
(10) Pub. No.: US 2013/0204074 A1
(43) Pub. Date: Aug. 8, 2013

(54) Method and Apparatus for Providing a Portable Neonatal Transport Incubator

(71) Applicants: Jeffrey C. Belval, Broomfield, CO (US); Phillip T. Brox, Frederick, CO (US); Harold Dean, IV, Ventura, CA (US); Brett P. Raver, Fort Collins, CO (US)

(72) Inventors: Jeffrey C. Belval, Broomfield, CO (US); Phillip T. Brox, Frederick, CO (US); Harold Dean, IV, Ventura, CA (US); Brett P. Raver, Fort Collins, CO (US)

(21) Appl. No.: 13/582,735

(22) PCT Filed: Mar. 4, 2011
(86) PCT No.: PCT/US11/27275

§ 371 Date: Apr. 11, 2013

Related U.S. Application Data
(60) Provisional application No. 61/310,439, filed on Mar. 4, 2010.

(51) Int. Cl. A61G 11/00

(52) U.S. Cl. CPC A61G 11/008
USPC 600/22

(57) ABSTRACT

Disclosed is a transport incubator capable of housing and maintaining a neonate in a controlled environment while being transported for medical care. The incubator comprises straps to secure the neonate, a battery-operated heater, a fan to circulate the warmed air, a source of humidity and at least one portable oxygen bottle. Capable of being worn by a user like a backpack, the incubator is portable and is useful for transport through difficult terrain. After making contact with a designated transport vehicle, the incubator can be disengaged from the backpack and mounted to a housing platform in the transport vehicle, the platform comprising a suspension system to minimize vibrations on the neonate. It is contemplated that the incubator system can accommodate an AC-powered battery during vehicular transport of the neonate to a medical care facility. A control unit displays data relevant to the controlled environment of the incubator and the neonate.

### CROSS REFERENCE APPLICATIONS

This application is a non-provisional application claiming the benefits of provisional application No. 61/310,439 filed Mar. 4, 2010.

### TECHNICAL FIELD OF ART

The disclosed device relates generally to a medical transport unit useful in emergency neonatal transport, and more specifically to a portable, compact neonate transport incubator useful in environments where transportation by vehicle, aircraft or gurney may not be readily available.

### BACKGROUND

An incubator is an apparatus used to maintain environmental conditions suitable for a newborn baby (neonate). Incubators typically consist of a source of controlled heat, humidity and oxygen. A servomechanism can provide continuous monitoring of the neonate's temperature and can control the heat within the unit.

Transport incubators, which are well known in the medical industry, are designed to provide a stable, thermal environmental for a neonate during transfer from place to place. Such transfer can involve transport to a hospital having the requisite critical care facilities sought for the neonate or transport within the hospital itself. Patient transport devices, such as stretchers, gurneys and other carts have long been used to transport incubators from place to place. In addition, many patient transport devices have been adapted for use with a variety of transportation vehicles, including ambulances, helicopters, and airplanes, to name a few. Transportation time can range from a few minutes, as in the case of transport within a hospital, to several hours, as in the case where transport must take place across large distances.

The transport of neonates presents particular problems when conveyance by vehicle, aircraft, gurney or stretcher may not be readily available. As can be imagined, there are a number of situations where conventional means of transport are not possible. For example, in the event of a natural disaster such as an earthquake, an ambulance may not be able to reach a target destination. Another foreseeable complication can result when neonatal transport is required in less industrialized countries or in rural settings. During transport between locations, disturbances such as potholes, bumps, turbulence or other inconsistencies can cause abrupt positional changes that can be transmitted to a neonate, thereby causing additional complications. Since the biological systems of a neonate may not be fully developed, even the smallest amount of vibrations transmitted to the neonate during transfer can have traumatic impacts.

The disclosed system provides an apparatus which combines the elements of a transport incubator with that of portability and adaptability. Where transport from a remote location may be required before a rendezvous with conventional transportation means can be made, the disclosed system provides for a neonatal transport incubator within which a neonate can be transferred safely. After the incubator is transferred to a transportation vehicle, the system addresses vibrations which may be encountered by the neonate. While the incubator is being transported from place to place, whether it be from remote location to a medical care facility or from a remote location to a transport vehicle which then transfers the neonate to the medical care facility, the disclosed device serves as a secure and effective ambulance for a neonate, one that is equipped with the basic elements of a conventional incubator.

### SUMMARY OF THE DISCLOSURE

The disclosed system provides a compact, rugged and portable neonate transport incubator which may be carried conveniently on a user's back in a backpack format.

The disclosed system provides an incubator construction having transparent closures which enable the viewing of a neonate at all times and can be conveniently operated to open when the neonate needs attention.

The disclosed system provides a compact and portable neonate transport incubator capable of maintaining the interior of the incubator at optimum temperature and humidity conditions for the benefit of the neonate.

The disclosed system provides a portable neonate transport incubator capable of isolating a neonate in a secure microenvironment and which minimizes thermal and radiative heat losses and reduces noise trauma.

The disclosed system provides a portable neonate transport incubator which restrains the movement of a neonate within the incubator without causing pressure injuries to the neonate or hindering its breathing and other vital functions.

The disclosed system provides a portable neonate transport incubator having a reclinable support which reduces risk of injury or trauma on the biological systems of a neonate.

The disclosed system provides a portable neonate transport incubator having a pad system which lends itself to ease of sterilization and/or disposal.

The disclosed system provides a modular neonate transport incubator which is readily transportable from place to place.

The disclosed system provides a modular neonate transport incubator having stowage capabilities.

The disclosed system provides a portable transport incubator having oxygen sources for feeding controlled amounts of oxygen into the incubator chamber.

The disclosed system provides a portable and rugged transport incubator that may be disposed in a transport vehicle with a reduction of vibration to the neonate.

The disclosed system provides a portable and rugged transport incubator which may itself serve as a crib.

The disclosed system provides a portable and rugged transport incubator which may itself serve as an ambulance.

The disclosed system provides a compact, rugged and portable transport incubator which is relatively lightweight.

The disclosed system provides a portable transport incubator which is a relatively low cost alternative to conventional transport incubators.

The disclosed system provides a portable transport incubator which is independent of sources of electrical energy and which relies on battery power so it can be used in rural areas or when failure of electric power has taken place as a result of unusual conditions.

The disclosed system provides a portable transport incubator which is easy to use in congested situations or under unusual conditions.

The disclosed system provides a modular neonate transport incubator capable of collecting and communicating system data from a remote location.

These and other features and advantages of the disclosed apparatus reside in the construction of parts and the combination thereof, the mode of operation and use, as will become more apparent from the following description, reference being made to the accompanying drawings that form a part of this specification wherein like reference characters designate corresponding parts in the several views. The embodiments and features thereof are described and illustrated in conjunction with systems, tools and methods which are meant to exemplify and to illustrate, not being limiting in scope.

### BRIEF DESCRIPTION OF THE FIGURES

FIG. 1 depicts one embodiment of the disclosed device being carried by means of its transport assembly.

FIG. 2 depicts an exploded perspective view of the embodiment shown in FIG. 1, the embodiment comprising an incubator mountable to a transport assembly.

FIGS. 3, 4 depict a method and apparatus for positioning the neonate in the embodiment shown in FIG. 1.

FIG. 5 depicts a pad embodiment contemplated for use with premature neonates.

FIG. 6 is a backside elevation view of the transport assembly embodiment shown in FIGS. 1, 2 as positioned adjacent a vertical support for the incubator.

FIG. 7 is a backside elevation view of the vertical support for the incubator shown in FIG. 1, whereby the frame and the straps of the transport assembly have been removed from view.

FIG. 8 depicts one embodiment of a platform to which the incubator of FIG. 2 can be mounted for transport in a transport vehicle.

Before explaining the disclosed embodiments in detail, it is to be understood that the embodiments are not limited in application to the details of the particular arrangements shown, since other embodiments are possible. Also, the terminology used herein is for the purpose of description and not of limitation.

### DETAILED DESCRIPTION OF THE FIGURES

The disclosed system provides, for a self-contained incubator unit having a controlled microenvironment suitable for the isolation and care of neonates and premature neonates. The disclosed system comprises an incubator that is removably mounted to a transport assembly. When desired, the incubator can be readily disengaged from the transport assembly and removably mounted to a portable support assembly situated in a transportation vehicle. The portable support assembly comprises a suspension system to limit vibrations encountered by the neonate during transport to a medical care facility.

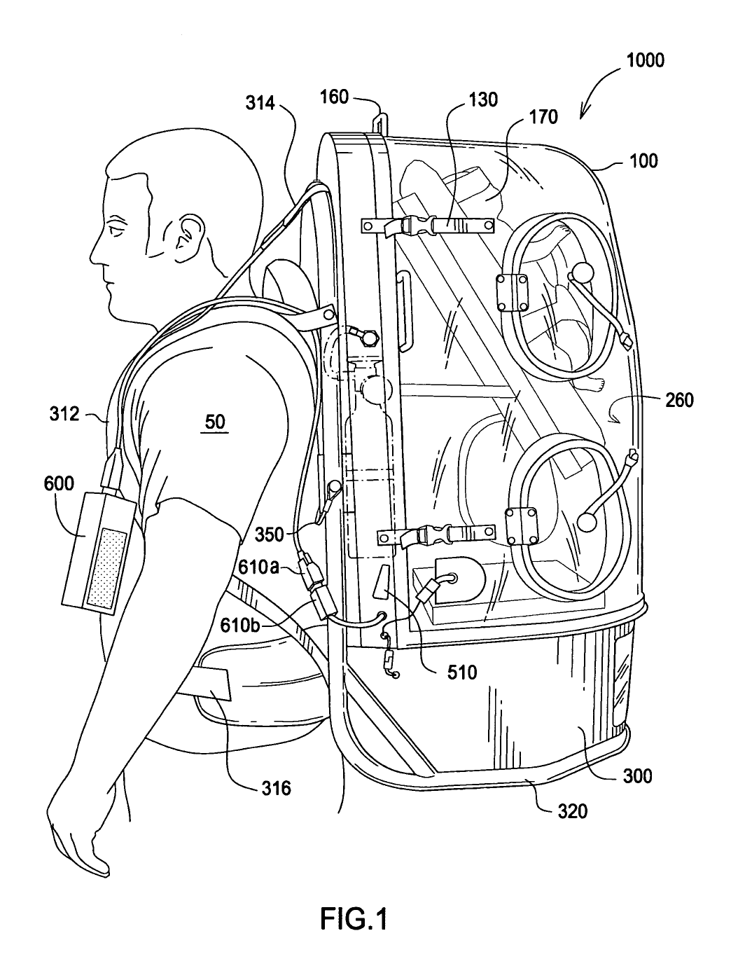

As shown in FIG. 1, system 1000 comprises incubator 100 and transport assembly 300. In operation, user 50 could don transport assembly 300 similar to the way a user would put on a backpacking backpack. For example, it is well known that first tightening a pack's compression straps causes the load to be small and stable before donning the pack. Shoulder straps 312 are then typically loosened so user 50 may place his arms through its padded portions whilst hefting system 1000 across his back. See also FIG. 7. After waist belt 316 is shut, user 50 may shrug the pack's weight up. Belt 316 can be tightened so that the hips, not the shoulders, will support most of the weight. Simultaneously, both shoulder straps 312 and then both of upper straps 314 are tightened to bring the top of the load toward the head of user 50 and until the pack feels balanced over the hips. If available, hip straps (not shown) can be simultaneously tightened to pull the bottom of the load toward the user's hips. Finally, chest strap 318 is shut across the user's chest and tightened. Balancing the weight of system 1000 on the hips helps to minimize the likelihood of injury to user 50 and to neonate 170 who is being transported in chamber 260.

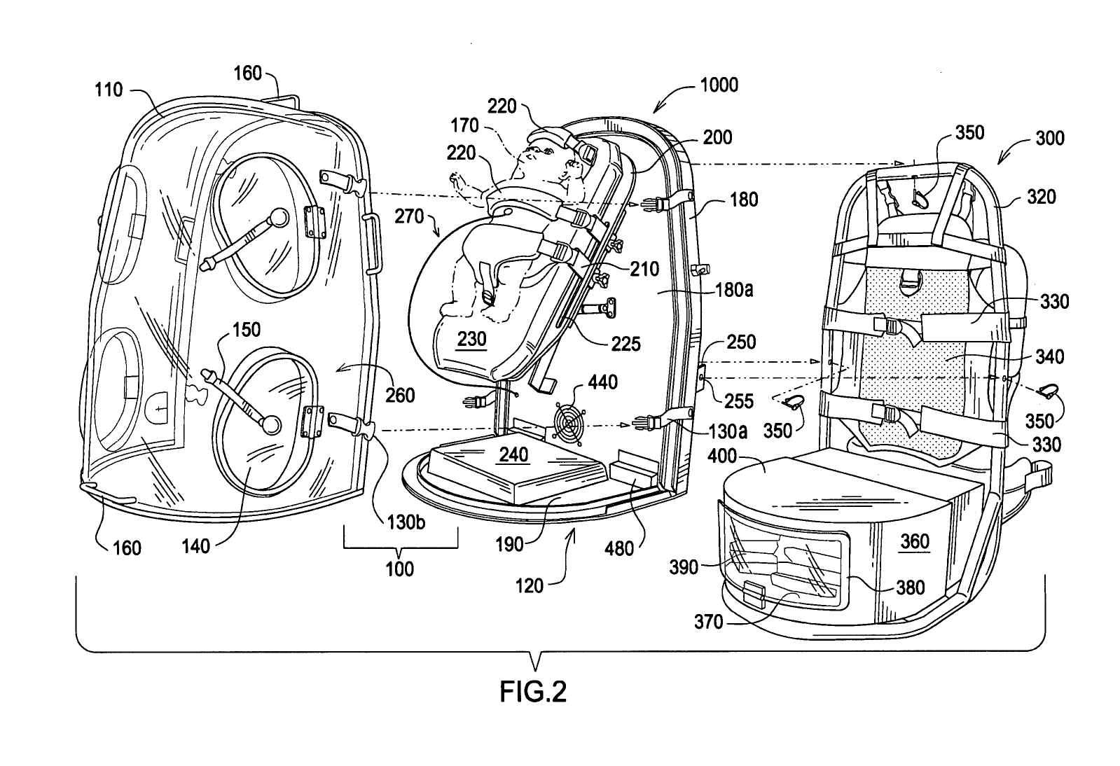

FIG. 2 depicts an exploded perspective view of system 1000. Incubator 100 comprises a double walled housing 110 which forms an insulating chamber 260 for neonate 170 when housing 110 is fastened to base assembly 120 by means of buckle mechanisms 130. Mechanism ends 130a and 130b mate one with another and can comprise metal, plastic or a combination thereof.

It is well known that visibility of a neonate is an important concern. Many incubator chambers are rigid box-like enclosures constructed of a clear plastic such as Plexiglas®, which can offer clear views of the neonate from multiple sides of the enclosure, but which can unfortunately fall short of serving as a good thermal insulator. In addition, the configuration of a box-like enclosure results in the trapping of air flow, causing air pockets and hindering ventilation. Because such prior art designs, made up of primarily parallel and flat planes, are prone to reverberation and resonance, it was also not uncommon for neonates to suffer noise trauma.

Housing 110 of the present device is constructed of a clear plastic material such as PETG, and offers about an 180° view of neonate 170. The domed shape of housing 110, which is comprised of complex curves combined with parallel planes, provides a system that can more optimally move air therethrough. The air layer between the two walls of incubator chamber 260 helps to reduce thermal loss from housing 110. A double-walled construction enables housing 110 to maintain a higher inner wall temperature, which reduces the radiative heat loss of the neonate. Conventional transport incubators typically operate in temperatures ranging from about −20° C. to about 40° C. The disclosed device has been shown to maintain a temperature of about 25° C. within chamber 260. In addition, the double-walled housing of the present device also helps reduce noise trauma to neonate 170, particularly during helicopter transport and the like. The air space between the wall layers provides for an acoustic air pressure buffer therebetween. It is contemplated that gases other than air could be employed in other embodiments.

Housing 110 comprises portholes 140 which can be hingedly opened for easy access to neonate 170 with a minimum of heat and oxygen loss. Portholes 140 can be securely closed by means of retaining straps 150. In some cases, an elastic shock cord could be selected. Those having skill in the art will readily appreciate that the retaining straps just described can be of any of various configurations. Handles 160 allow a user to align housing 110 with base assembly 120 to effect a close fit thereto. Conversely, handles 160 allow a user to disengage housing 110 without too much difficulty to provide unimpeded access to neonate 170 as needed.

Base assembly 120 provides the foundation of the microenvironment which isolates neonate 170. As shown, base assembly 120 comprises vertical support 180 and base 190. Backboard 200 provides a stable plane of support for neonate 170 and is hingedly connected to vertical support 180. It is well known that the biological systems of neonates can be immature and highly susceptible to trauma caused by pressure. Thus, in one embodiment, backboard 200 is positioned at a 30° recline angle in an effort to alleviate pressure or trauma that can be suffered by neonate 170. While it has been determined that an approximate 30° recline angle can be suitable to help keep a neonate's airway open and to alleviate concerns with pressure placed on the neonate's lungs, groin, and heart, it is contemplated that other angles may suffice depending on the various parameters involved in any particular neonatal transport situation. Those having skill in the art would appreciate that other recline angles may be suitable to optimize the positioning of a neonate to prevent the transfer of forces, such as gravity, to the vulnerable biological systems of the neonate. In such cases, the dimensions of the system 1000 may have to be reconfigured.

Neonate 170 can be secured to backboard 200 by means of a plurality of restraints 210 and associated padding 220. Restraints 210 permit safe transport of neonate 170 who may already be at risk due to a medical condition and may prevent further risk of injury to neonate 170 within incubator 100. It is contemplated that restraints 210 can comprise nylon webbing; however, any suitable material of construction may be employed. It is contemplated that a neonate may be restrained at the head and across the chest and pelvis. This arrangement helps to ensure the head is supported, the airway and other vital areas are kept open, and a medical professional may still have adequate access to treat the neonate.

Restraints 210 are shown to be insertable through slots 225 whereby neonate 170 may be restrained to backboard 200. One having skill in the art would recognize that various configurations for preventing the movement of a neonate are possible without departing from the spirit and scope of the present disclosure. Pad 230 provides for the comfort and protection of neonate 170. It is contemplated that pad 230 can be covered with a material that can be readily sanitized. Alternately, pad 230 could be disposable. It may also be removable and transportable with the neonate as needed.

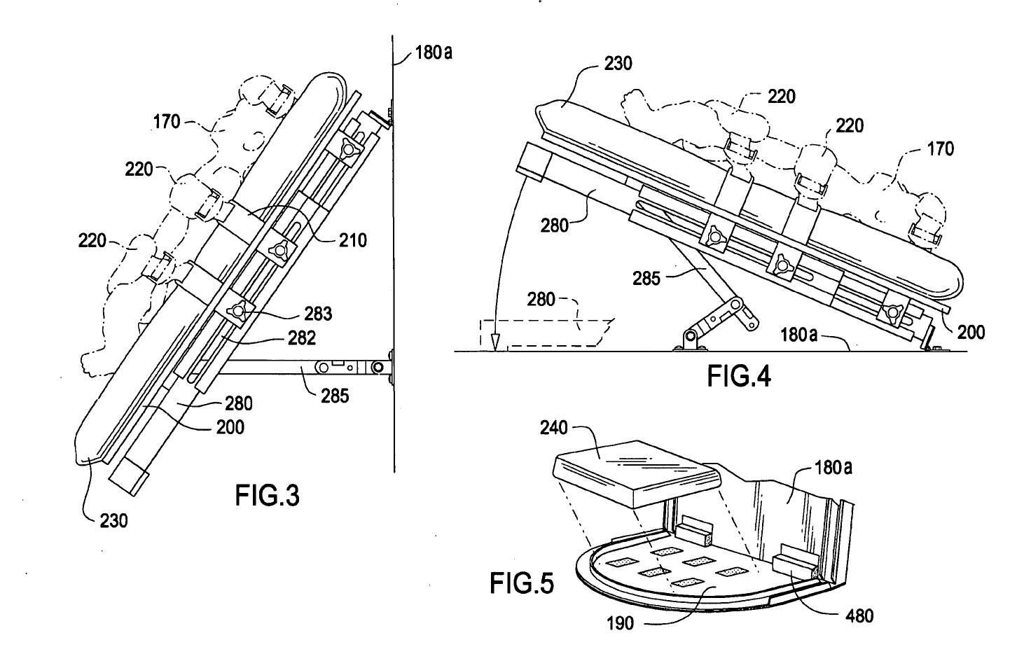

Referring now to FIG. 3, backboard 200 and neonate 170 are shown in a reclined position. Backboard 200 is supported by bracket 280; bracket arm 285 is in an extended mode. Backboard 200 is adjustably slidable along slots 282 of bracket 280 by means of screw fasteners 283. FIG. 4 illustrates backboard 200 and neonate 170 being adjusted towards a vertical position parallel to wall 180b of vertical support 180. Bracket arm 285 is in a partially collapsed mode.

As stated above, neonate 170 can be situated on backboard 200 which may be hingedly fixed at a suitable recline angle. This configuration presupposes neonate 170 is born after about 32 weeks to about 40 weeks of gestation. In cases involving premature neonates, namely those born prior to about 32 weeks of gestation, it has been advised that the infant should ideally be situated in a horizontal position. Horizontally positioned pad 240 provides for the comfort and protection of such neonates (see FIGS. 2, 5). Pad 240 can be affixed to base 190 by hook and loop closures such as Velcro® or other suitable means. Pad 240 can be covered with a material that can be readily sanitized. Like pad 230, it could be disposable and/or removable and transportable as needed. While pads 230, 240 comprise foam, other mattress materials may be employed. In cases involving premature neonates, backboard 200 may be vertically fixed as explained in FIG. 4 so as not to impede the proper placement and restraint of a neonate on pad 240. It is contemplated that other embodiments could feature a removable backboard and/or associated components.

Similar to the restraint system described above, a plurality of restraints (not shown) and associated padding (not shown) may be used to permit safe transport of a premature neonate within incubator 100. Because a premature neonate is typically smaller in size than a fully developed neonate, it is contemplated that the restraint system could diverge from that required to secure and restrain neonate 170. It can be expected that incubator 100 will be capable of accommodating infants of various sizes.

Shelf 360 depicted in FIG. 2 is adapted to receive base 190. Shelf 360 comprises storage compartment 370 which can be used to store items 390. Cover 380 can be constructed from plastic for ease of visibility of items 390; however any suitable material of construction may be utilized. Lid 400 provides access to compartment 370 and to battery 410 described in FIG. 7. Shelf 360 and lid 400 can be constructed from aluminum or other lightweight metal alloy. To lower the weight of the overall system, it is contemplated that perforated metal or wire mesh could be employed.

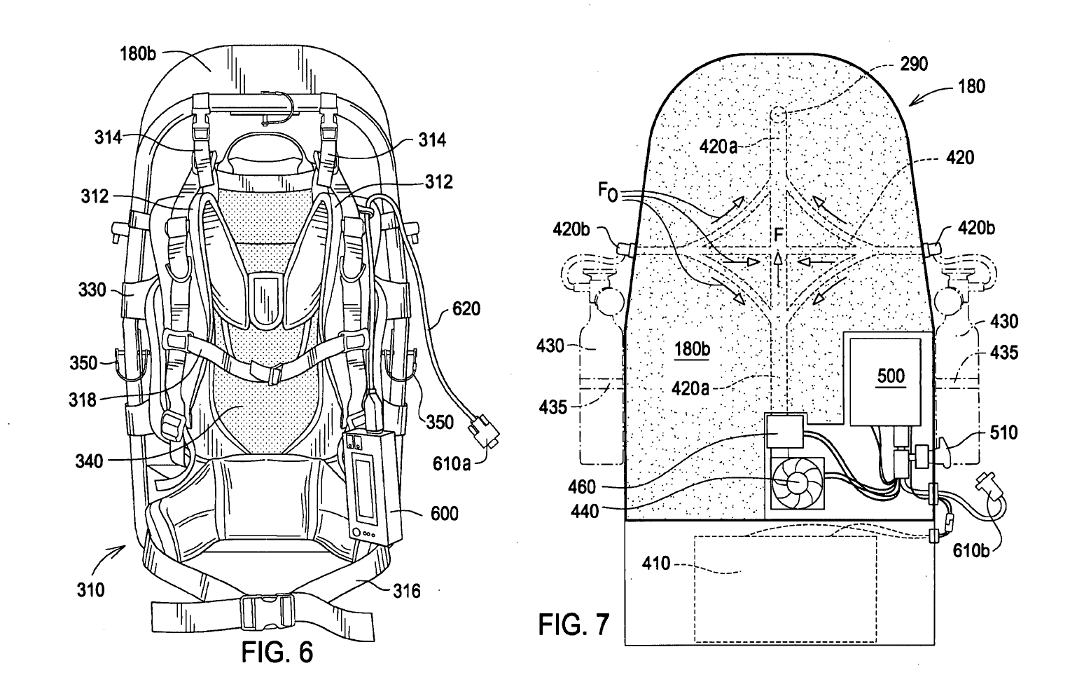

Base assembly 120 can be secured to transport assembly 300 by means of pins 350 mateable with receiving holes 255 located on plate 250 of vertical support 180. See also FIG. 6. When desired, incubator 100 can be readily disengaged from transport assembly 300 by removing pins 350 from receiving holes 255. As shown in FIGS. 2, 6, transport assembly 300 comprises frame 320 to which attachment straps 330 can be fastened. Frame 320 loosely resembles an external frame backpack frame. It is contemplated that frame 320 can be used to carry loads greater than about 20 kg (about 40 lb). In one embodiment, it was determined that system 1000 weighed about 28 kg (about 60 lb). To accommodate strength and weight considerations, frame 320 can be constructed from aluminum or other lightweight metal alloy.

Attachment straps 330 and tautly-stretched netting 340 prevent contact between frame 320 and a user's back. In addition to comfort, netting 340 provides for air circulation between frame 320 and the user's back. Attachment straps 330 support strap system 310 illustrated in FIG. 6. Strap system 310 is a Vari-Quick harness system derived from a Kid Comfort II manufactured by Deuter USA.

As has been generally discussed herein, an incubator is capable of providing a microenvironment for a neonate in which heat, humidity and oxygen can be controlled. FIG. 7 depicts one arrangement of the various components typically used to provide a controlled microenvironment. Vertical support 180 comprises a front wall 180a and a back wall 180b defining a hollow space therebetween (not shown) to house components which create the isolating microenvironment needed for the care of neonate 170. Walls 180a, 180b can be constructed from aluminum or other lightweight metal alloy. There exist ducts for circulating air through vertical support 180 and into the interior of incubator chamber 260. The hollow space adjacent the ducts can be filled with lightweight expanding insulating foam (not shown) which serves to fix the ducting in place and to provide sound damping and thermal insulation.

The lower right corner of back wall 180b is cut away to show various internal components: an electric motor (fan blower 440), an electric heating device 460, circuit board 500 and control 600 which is in electrical communication therewith (see FIGS. 1, 6). Air ventilation circuit 420 comprises a ducting system constructed from a plastic material such as PVC. Circuit 420 administers a regulated flow of oxygenated, tempered and humidified air to neonate chamber 260. Fan blower 440 causes filtered air to flow through duct 420a from chamber 260 in direction F whereby it is forced across one or more heated plates of electric heater 460. Warmed air reenters chamber 260 from duct 420a through at least one orifice 290 thus completing the recycle of tempered air. Orifice 290 injects air into chamber 260. Humidifying device 480 comprises a pair of wetted sponges secured in an open-ended mesh metal housing (see FIGS. 2, 5).

A pair of portable oxygen canisters 430 may be mounted in corresponding holsters 435 situated on transport assembly 300. In one embodiment, the system is regulated to provide an air/oxygen mixture at a ratio of about 1:3. As shown, each canister 430 may introduce oxygen from inlet 420b in direction Fₒ into duct 420a from three locations. It has been determined that a 1 kg canister of oxygen can provide up to about 1.5 hours to about 3 hours of fresh air to chamber 260. Toggle (on/off switch) 510 activates circuit board 500 which controls the system's components. Toggle 510 is positioned on vertical support 180 at a location that can be easily accessed by user 50.

Control 600 depicted in FIG. 6 provides a user interface for the control and display of conditions within the microenvironment of chamber 260 including data relating to neonate 170, such as body temperature and blood oxygen saturation. System power can also be monitored. Control 600 comprises cable 620 which is connectable to circuit board 500 upon a mating of quick connection ends 610a and 610b. Thermocouple 270 can be mounted on neonate 170 as shown in FIG. 2 to provide body temperature information to circuit board 500. A thermostat (not shown) can be used to automatically or manually adjust the temperature within chamber 260 as needed. Cable 620 of control 600 can be inserted through various slots on shoulder strap 312 so control 600 can be positioned for easy access by user 50. Control 600 can be affixed to strap system 310 by hook and loop closures or other means if desired.

The transportation of neonates presents particular problems since it is necessary to maintain the neonate in a controlled environment in an incubator and to monitor and control various conditions during all phases of the trip. Thus, it is desirable to provide a power source that is not dependent upon connection to a vehicle or other external power source. Battery 410 comprises a lead-acid battery chosen for its reliability and its ability to provide a high rate of discharge if a large amount of heat is required in cold environments. It is well known that lead-acid batteries are heavy and reducing weight is an important concern for both user 50 and the transport personnel who at times must lift system 1000. Therefore, those skilled in the art will readily appreciate that other types of battery power could be incorporated.

Although it is not shown, it is contemplated that incubator 200 could include a light source that is useful to medical personnel who examine neonate 170. To minimize adverse and undesirable effects of such a light source on neonate 170, a light shield could be utilized. It is believed that a shade curtain attachable to housing 110 could also be helpful to shield neonate 170 from glare or sunlight. Although not shown, ice packs can be used for cooling purposes. These items and others can be stored in compartment 370 if desired.

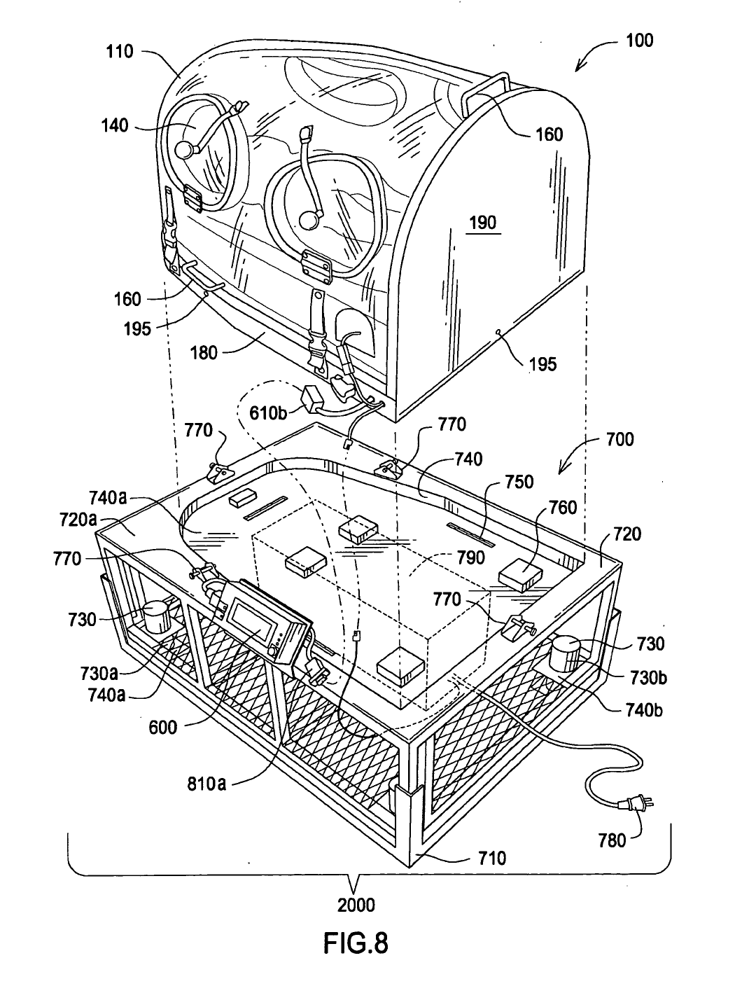

As shown in FIG. 8, system 2000 comprises incubator 100 and portable support assembly 700. After being disengaged from transport assembly 300, incubator 100 is removably mounted to portable support assembly 700 which can reside in a transport vehicle. It is contemplated that known means can be used to restrain support assembly 700 to a surface in a transport vehicle.

Support assembly 700 comprises bracket 710 which houses pedestal 720 and a plurality of suspension mechanisms 730. Each of suspension mechanisms 730 comprise a dual-component system which serves to limit vibrations encountered by a neonate during transport to a medical care facility. A first component 730a is positioned between a pair of flanges 740a, 740b. Flanges 740a are located adjacent an inner bottom surface of bracket 710. Flanges 740b are located adjacent an inner bottom surface of pedestal frame 720. A second component 730b is positioned atop flange 740b. In the embodiment shown, support assembly 700 comprises four sets of suspension mechanisms 730.

Neonatal patients are particularly susceptible to injury or harm. One serious concern, but not the only serious concern, is intraventricular hemorrhage, whereby blood vessels in the brain rupture. Because the blood vessels in the brain of neonatal patients are underdeveloped and not prepared for significant stress, vibrations and the accelerations of the patient as a result of the vibrations may cause impact to the blood flowing through those vessels.

The one or more dual-component suspension mechanisms 730 provide a system that can decouple neonate 170 from the transportation vehicle in an effort to minimize vibrations. Suspension mechanisms 730 may include springs configured to absorb energy stemming from positional changes or dampeners configured to dampen the absorption and/or release of energy through springs, or a combination thereof. While the suspension mechanisms illustrated show separate components, such devices may be a single component, and may include other spring mechanisms such as elastomers. Those having skill in the art would appreciate the numerous configurations that can be applied to buffer the incubator 100 from vibration without departing from the scope and spirit of the disclosure.

Pedestal 720 comprises top surface 720a having recessed area 740 for receiving vertical support 180. Plates 250 (see FIG. 2), which previously served as a receiver support for pins 350, are vertically insertable into receiving slots 750 located on pedestal 720. Cushions 760 provide a flexible interface between top surface 740a and wall 180b of vertical support 180. Incubator 100 can be secured to support assembly 700 by means of pins 770 mateable with receiving holes 195 located on base 190. Handles 160 allow a user to manipulate incubator 110 with relative ease. When desired, incubator 100 can be readily disengaged from support assembly 700 by emergency transport or medical personnel by releasing pins 770 from receiving holes 195.

It is contemplated that one or more portable oxygen canisters (not shown) may be stored in support assembly 700 in the hollow space defined between bracket 710 and pedestal 720. It is also contemplated that plug 780 can be used to provide power to battery 790 so as to maintain the microenvironment of incubator 100. In addition, it is contemplated that support assembly 700 can be a primary or ancillary device for emergency neonatal transport in helicopters, other aircraft and vehicles.

Control 600, which can be disengaged from transport assembly 300, is shown mounted to support assembly 700. Control 600 is connectable to circuit board 500 upon a mating of quick connection ends 810a and 610b. In this configuration, control 600 controls and displays conditions within the microenvironment of chamber 260, body temperature and blood oxygen saturation data relating to neonate 170, and system power, during vehicular transport to a medical care facility. It is contemplated that systems 1000 and 2000 can be adapted for data collection and remote transmission of said data

While a number of exemplifying features and embodiments have been discussed above, those of skill in the art will recognize certain modifications, permutations, additions and subcombinations thereof. Other alternate embodiments of the present apparatus could easily be employed by those skilled in the art to achieve the functions of the present apparatus and methodology. It is to be understood that additions, deletions, and changes may be made to the system and various internal and external functions disclosed herein, and still fall within the true spirit and scope of the disclosure. No limitation with respect to the specific embodiments disclosed herein is intended or should be inferred.

We claim:

1. A neonate transport incubator comprising:
an arcuate transparent casing having a double-walled construction, said casing further comprising a pair of covered portholes;
a base assembly having one or more supports capable of holding and restraining a neonate;
said base assembly further comprising an air delivery unit and a temperature control system;
said casing being fastenable to said base assembly to form a closed microenvironment for a neonate housed therein; and
wherein said air delivery unit and said temperature control system provide controlled heat, humidity and oxygen to sustain conditions for the benefit of the neonate.

2. The incubator of claim 1 further comprising a transport assembly having a strap system attachable to said incubator, whereby said strap system may be carried on a user's back in a backpack format.

3. The incubator of claim 1, wherein said casing further comprises an air space capable of minimizing thermal and radiative heat losses and reducing noise.

4. The incubator of claim 1 further comprising buckles to fasten said casing to said base assembly.

5. The incubator of claim 1, wherein said covered portholes can be hingedly opened to provide access therethrough,

6. The incubator of claim 1, wherein one of said one or more supports of said base assembly can be reclined.

7. The incubator of claim 2, wherein said transport assembly further comprises storage.

8. The incubator of claim 1, wherein said air delivery unit further comprises at least one oxygen source for feeding controlled amounts of oxygen thereto.

9. The incubator of claim 1 further comprising a support assembly having a suspension system to reduce vibrations transferred to said neonate during a vehicular transport phase.

10. The incubator of claim 1 further comprising a control mechanism to control and display conditions within said microenvironment, body temperature and blood oxygen saturation data relating to said neonate and system power.

11. The incubator of claim 9 further comprising a control mechanism to control and display conditions within said microenvironment, body temperature and blood oxygen saturation data relating to said neonate and system power.

12. A support assembly to receive a modular transport incubator, said assembly comprising:
a bracket housing a pedestal;
said pedestal having a receptacle for receiving a base assembly of a neonatal transport incubator;
a neonatal transport incubator removably mounted in said receptacle, said neonatal incubator having an arcuate transparent casing and further comprising an air delivery unit and a temperature control system; and
said bracket having a plurality of suspension mechanisms, each of said plurality serving to limit vibrations encountered by a neonate housed in said incubator during a vehicular transport phase.

13. The assembly of claim 12, wherein one or more of said plurality of suspension mechanisms further comprises a dual component system, a first component positionable adjacent an inner wall of said bracket, a second component positionable adjacent an inner wall of said pedestal.

14. The assembly of claim 12, wherein one or more of said plurality of suspension mechanisms comprises springs and/or elastomers.

15. The assembly of claim 12 further comprising a control mechanism to control and display conditions within said incubator including body temperature and blood oxygen saturation data relating to said neonate and system power.

16. The assembly of claim 12, wherein said bracket further comprises at least one oxygen source for feeding controlled amounts of oxygen to said air delivery unit.

17. A modular neonate transport incubator system comprising:
an arcuate transparent casing having a double-walled construction, said casing being fastenable to a base assembly to form a transport incubator unit for a neonate housed therein, said base assembly having one or more supports capable of holding and restraining a neonate, said base assembly further comprising a source of controlled heat, humidity and oxygen;
a transport assembly having a strap system attachable to said incubator unit, whereby said strap system may be carried on a user's back in a backpack format;
a support assembly having a suspension system to reduce vibrations transferrable to said neonate during a vehicular transport phase; and
a control mechanism to display and control an internal incubator temperature, system power, and body temperature and blood oxygen saturation data relating to said neonate.

18. The system of claim 17, wherein said control mechanism is in removable engagement with said transport assembly in combination with said incubator.

19. The system of claim 17, wherein said control mechanism is in removable engagement with said support assembly in combination with said incubator.

20. A method for providing a modular neonate transport incubator system, the method comprising the steps of
providing a transport assembly having a strap system capable of being carried by a user in a backpack format;
removably mounting to said transport assembly a neonatal transport incubator having an transparent double-walled casing and a base assembly, said base assembly having one or more supports capable of holding and restraining a neonate, said base assembly further comprising a source of controlled heat, humidity and oxygen;
disengaging said transport assembly from said neonatal transport incubator; and
removably mounting said neonatal transport incubator to a support assembly having a suspension system to reduce vibrations transferrable to said neonate during a vehicular transport phase.
